(19) United States
(12) Patent Application Publication
(10) Pub. No.: US 2023/0302978 A1
(43) Pub. Date: Sep. 28, 2023

(54) INTERIOR STRUCTURE FOR VEHICLE

(71) Applicant: MORIROKU TECHNOLOGY COMPANY, LTD., Tokyo (JP)

(72) Inventor: Jungo Horiyama, Tokyo (JP)

(21) Appl. No.: 18/177,267

(22) Filed: Mar. 2, 2023

(30) Foreign Application Priority Data
Mar. 23, 2022 (JP) 2022-046880

(51) Int. Cl. B60N 2/75

(52) U.S. Cl. CPC B60N 2/793

(57) ABSTRACT

An interior structure for vehicle includes a first member and a second member that can be superimposed on the first member and that is elastically deformable. A second superimposed surface of the second member includes a plurality of recesses that are open toward a first superimposed surface of the first member, and that are independent of each other without communicating with each other. The plurality of recesses include a plurality of large recesses having a large volume, and a plurality of small recesses having a smaller volume than the volume of the plurality of large recesses. Portions in which the plurality of large recesses are located form a low-elasticity portion of the second member. Portions in which the plurality of small recesses are located form a high-elasticity portion of the second member.

### BACKGROUND OF THE INVENTION

The present invention relates to an interior structure for vehicle including a cushioning material.

### BRIEF DESCRIPTION

A cushioning material is provided in an interior of a passenger compartment of a passenger vehicle to provide a certain cushioning property. Japanese Patent Publication No. 2020-138667 discloses a technique of the related art related to an interior structure for vehicle including a cushioning material inside.

The interior structure for vehicle disclosed in Japanese Patent Publication No. 2020-138667 is an armrest provided in a door trim of a vehicle. The armrest includes a base material (first member); a cushioning material (second member) superimposed on the base material; and a skin covering the cushioning material.

Among interior components, there are various needs for a cushioning property or a sense of touch of an armrest. For example, in the case of changing the cushioning property depending on a portion of the armrest, it is considered that a plurality of cushioning materials having different cushioning properties are prepared, the soft (low-elasticity) cushioning material is disposed in a portion that is set to be soft, and the hard (high-elasticity) cushioning material is disposed in a portion that is set to be hard. Further, it is also considered that the cushioning property of the armrest is adjusted by superimposing the plurality of cushioning materials. However, the armrest including the plurality of cushioning materials is expensive.

An object of the invention is to provide an interior structure for vehicle having different cushioning properties depending on a portion, while suppressing the cost.

### SUMMARY OF THE INVENTION

According to the invention, there is provided an interior structure for vehicle including: a first member having a first superimposed surface; and a second member having a second superimposed surface superimposed on the first superimposed surface, and being elastically deformable. The second member includes a low-elasticity portion that is easy to be elastically deformed, and a high-elasticity portion that is hard to be elastically deformed than the low-elasticity portion. One of the first superimposed surface and the second superimposed surface includes a plurality of recesses that are open toward the other superimposed surface, and that are independent of each other without communicating with each other. The plurality of recesses include a plurality of large recesses having a large volume, and a plurality of small recesses having a smaller volume than the volume of the plurality of large recesses. Portions in which the plurality of large recesses are located form the low-elasticity portion of the second member. Portions in which the plurality of small recesses are located form the high-elasticity portion of the second member.

Since the second member is easy to be deformed in the portions in which the plurality of large recesses are located, the portions form the low-elasticity portion of the second member. Since the second member is hard to be deformed in the portions in which the plurality of small recesses are located, the portions form the high-elasticity portion of the second member. A cushioning property of the interior structure for vehicle can be changed by only the second member which is a single body, through combining the recesses having different volumes, instead of a combination of a plurality of the second members. The interior structure for vehicle can have different cushioning properties depending on a portion, while suppressing the cost.

According to the invention, there is provided an interior structure for vehicle including: a first member having a first superimposed surface; and a second member having a second superimposed surface superimposed on the first superimposed surface, and being elastically deformable. The second member includes a low-elasticity portion that is easy to be elastically deformed, and a high-elasticity portion that is hard to be elastically deformed than the low-elasticity portion. One of the first superimposed surface and the second superimposed surface includes a plurality of recesses that are open toward the other superimposed surface, and that are independent of each other without communicating with each other. Shapes and volumes of the recesses are the same as each other. The plurality of recesses include a dense portion in which a spacing between the recesses is set to be narrow, and a sparse portion in which a spacing between the recesses is set to be wider than the spacing of the dense portion. The dense portion forms the low-elasticity portion of the second member. The sparse portion forms the high-elasticity portion of the second member.

Since the recesses are dense in the dense portion, the dense portion forms the low-elasticity portion of the second member, and since the recesses are scattered in the sparse portion, the sparse portion forms the high-elasticity portion of the second member. A cushioning property of the interior structure for vehicle can be changed by only the second member which is a single body, through changing the spacing between the recesses, instead of a combination of a plurality of the second members. The interior structure for vehicle can have different cushioning properties depending on a portion, while suppressing the cost.

It is preferable that the second superimposed surface of the second member includes the plurality of recesses. Manufacturing is easier when the recesses are formed in the second member that is elastically deformable than when the recesses are formed in the first member having a predetermined rigidity.

It is preferable that the plurality of recesses are located in a staggered pattern as a whole. Namely, the plurality of recesses are unbiasedly and evenly located on the first superimposed surface or on the second superimposed surface. The interior structure for vehicle has a constant cushioning property regardless of the portion thereof.

It is preferable that the plurality of recesses have a truncated conical shape. When the second member is manufactured by molding using a mold, the second member is easily released from the mold.

### BRIEF DESCRIPTION OF THE DRAWINGS

FIG. 1 is a diagram describing a passenger compartment of a passenger vehicle including an interior structure for vehicle according to a first embodiment;

FIG. 2 is a cross-sectional diagram taken along line 2-2 of FIG. 1;

FIG. 3 is an enlarged diagram of a portion surrounded by a line 3 of FIG. 2;

FIG. 4 is a perspective diagram of a second member having a plate shape before being superimposed on a first member illustrated in FIG. 2;

FIG. 5 is a diagram describing the second member surrounded by a line indicated by 5 in FIG. 4;

FIG. 6 is a diagram describing an action of the interior structure for vehicle according to the first embodiment;

FIG. 7 is a diagram describing a configuration and an action of an interior structure for vehicle according to a second embodiment;

FIG. 8 is a diagram describing a configuration and an action of an interior structure for vehicle according to a third embodiment; and

FIG. 9 is a diagram describing positions of recesses of a second member illustrated in FIG. 8.

### DETAILED DESCRIPTION OF THE PREFERRED EMBODIMENTS

Incidentally, in the description, left-right indicates left-right with reference to an occupant of a vehicle (vehicle width direction), and front-rear indicates front-rear with reference to a traveling direction of the vehicle. In addition, in the drawings, Fr represents the front, Rr represents the rear, L represents the left when viewed from the occupant, R represents the right when viewed from the occupant, Up represents the top or up, and Dn represents the bottom or down.

### First Embodiment

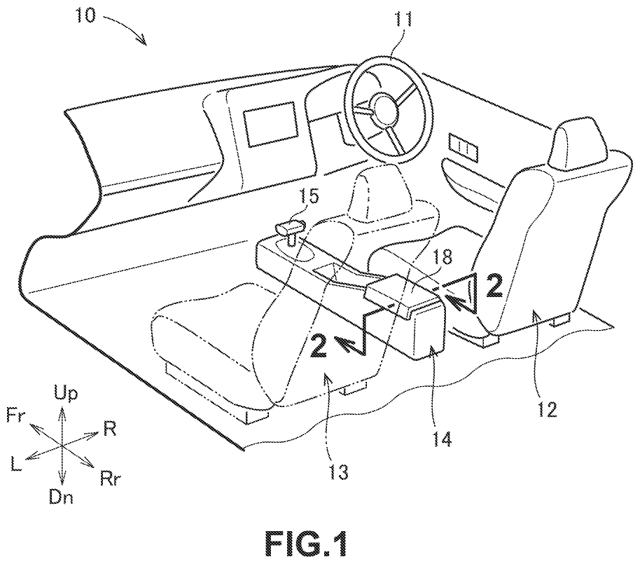

As illustrated in FIG. 1, a vehicle 10 includes a driver's seat 12 disposed behind a steering wheel 11 in the vehicle; a passenger's seat 13 disposed next to the driver's seat 12 in the vehicle width direction; and a center console 14 disposed between the passenger's seat 13 and the driver's seat 12. A shift lever 15 for shifting is provided in a front portion of the center console 14.

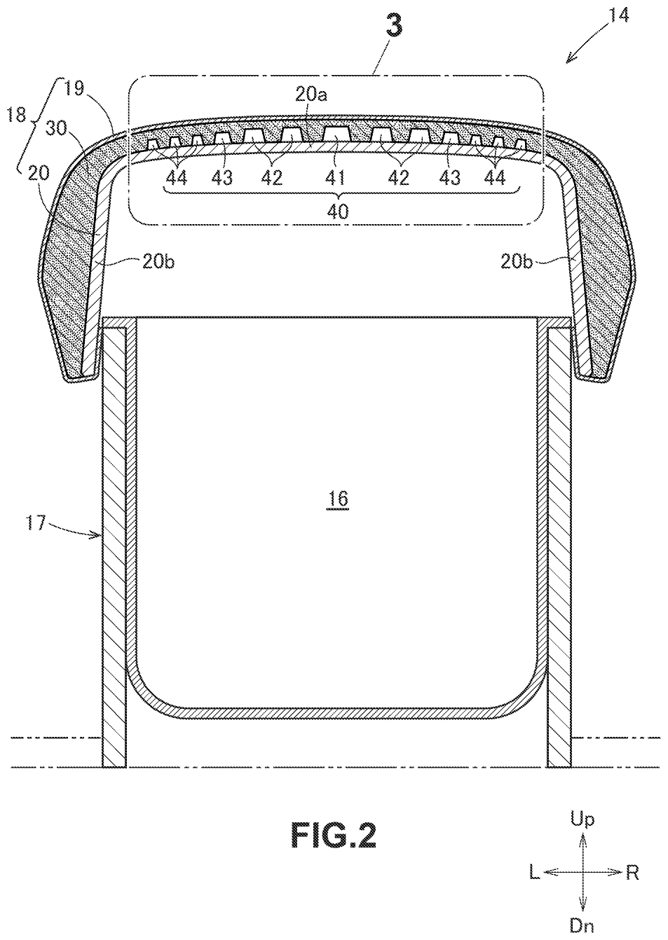

Referring to FIG. 1 and FIG. 2, the center console 14 further includes a storage portion 17 having a box shape and having a storage space 16 inside, the storage space 16 being capable of storing items, and an armrest 18 (interior structure for vehicle) serving as an elbow rest and covering an opening of the storage portion 17. The armrest 18 is connected to the storage portion 17 via an opening and closing mechanism (not illustrated) capable of opening and closing the opening of the storage portion 17. A detailed description of the opening and closing mechanism will be omitted.

The armrest 18 includes a base material 20 (first member); a cushioning material 30 (second member) superimposed on the base material 20; and a skin 19 covering the cushioning material 30.

The base material 20 includes a main body portion 20a capable of supporting an occupant's arm with an up-down direction set as a thickness direction, and wall portions 20b and 20b extending from both ends of the main body portion 20a toward the storage portion 17. The main body portion 20a is slightly curved to bulge upward. The base material 20 is made of, for example, a resin material. The base material 20 may be any material as long as the base material 20 supports the cushioning material 30 and the skin 19 and has a predetermined rigidity capable of maintaining the shape of the armrest 18.

The cushioning material 30 is made of, for example, a foam material such as urethane. The cushioning material 30 may be any material as long as the cushioning material 30 has a predetermined thickness and is elastically deformable.

The skin 19 is, for example, synthetic leather or cloth. The skin 19 may be any material as long as the skin 19 covers the cushioning material 30.

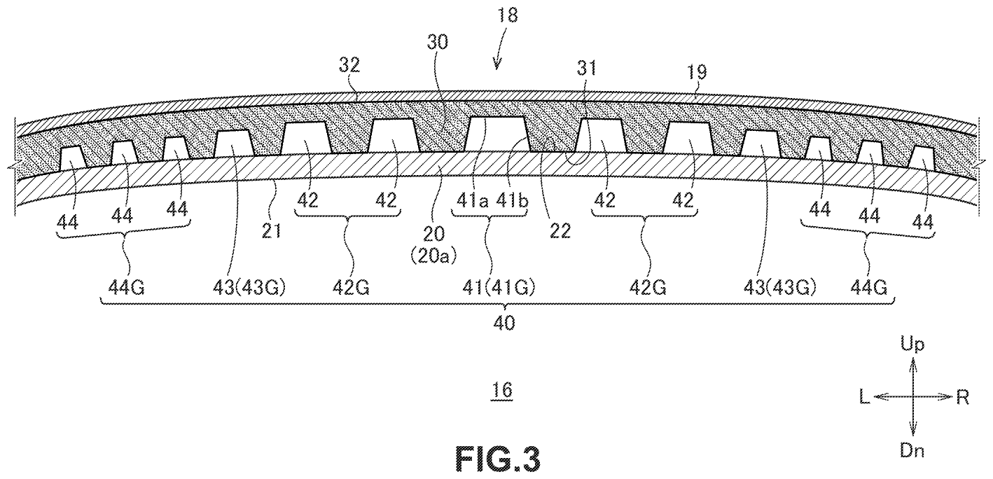

Referring to FIG. 3, a surface of the base material 20 which is exposed to the storage space 16 is referred to as an exposed surface 21, and a surface of the base material 20 which is opposite the exposed surface 21 and on which the cushioning material 30 is superimposed is referred to as a first superimposed surface 22.

A surface of the cushioning material 30 which is superimposed on the first superimposed surface 22 of the base material 20 is referred to as a second superimposed surface 31, and a surface of the cushioning material 30 which is opposite the second superimposed surface 31 and which is covered with the skin 19 is referred to as a covered surface 32.

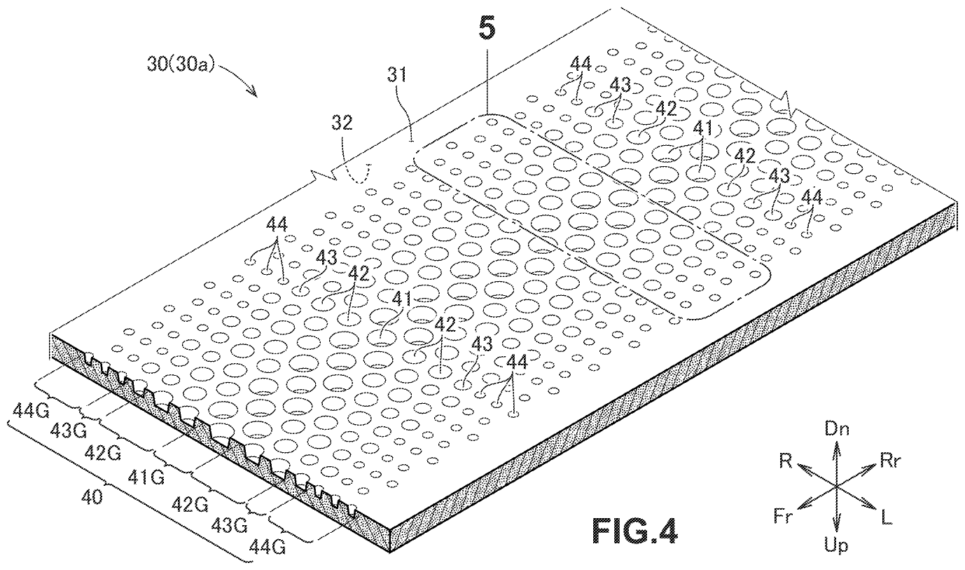

Referring to FIG. 3 and FIG. 4, incidentally, FIG. 4 illustrates a part 30a of a portion of the cushioning material 30 having a plate shape before being superimposed on the base material 20, the portion being capable of being superimposed on the main body portion 20a of the base material 20.

The second superimposed surface 31 of the cushioning material 30 includes a plurality of recesses 40 that are open toward the first superimposed surface 22 of the base material 20. The insides of the plurality of recesses 40 do not communicate with each other. Namely, the recesses are independent of each other.

The plurality of recesses 40 include a plurality of first recesses 41 (large recesses) to a plurality of fourth recesses 44 (small recesses) having different volumes. In the first embodiment, four types of the recesses 40 are provided, but the number of the recesses 40 may be any number as long as two or more types of the recesses 40 are provided. The volume decreases in order from the first recesses 41 to the fourth recesses 44. Namely, the volume of the first recesses 41 is at its largest, and the volume of the fourth recesses 44 is at its smallest. Incidentally, in the first embodiment, the “large recess” is a largest recess, and the “small recess” is a smallest recess, but the large recess and the small recess can be appropriately selected from the first recess 41 to the fourth recess 44 as long as a relative size relationship is satisfied.

The first recess 41 has a truncated cone shape. Namely, the first recess 41 has a bottom surface 41a of which an edge has a circular shape, and a side surface 41b that is increased in inner diameter from a peripheral edge of the bottom surface 41a toward a base material 20 side. Similarly, the second recess 42 to the fourth recess 44 have a truncated cone shape.

A diameter of an edge of the recess 40 is at its largest in the first recess 41, and is at its smallest in the fourth recess 44. A depth of the recess 40 is at its deepest in the first recess 41, and is at its shallowest in the fourth recess 44.

Incidentally, the shape of the recesses 40 is not limited to a truncated cone shape, and can be changed to a hemispherical shape, a columnar shape, or the like as appropriate.

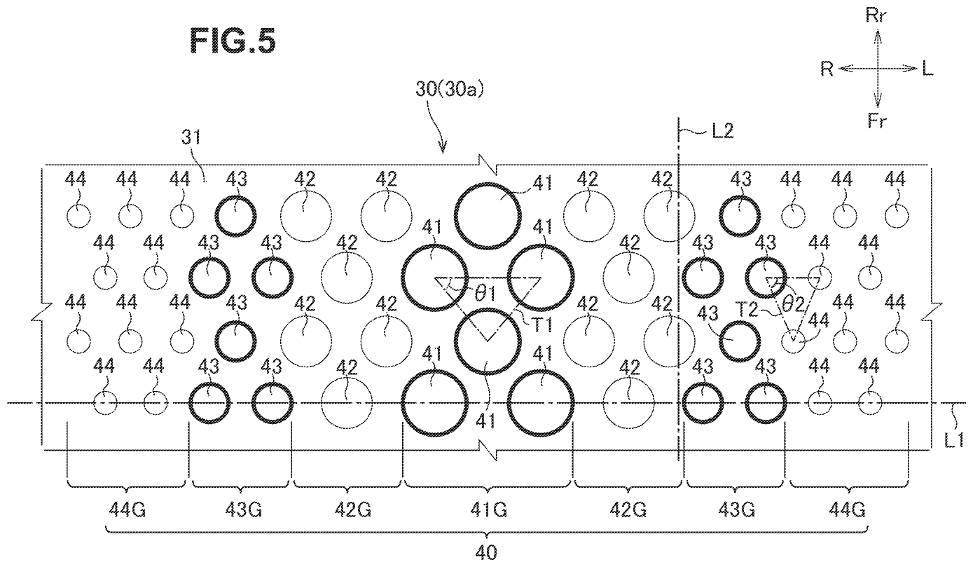

Referring to FIG. 4 and FIG. 5, the plurality of first recesses 41 are arranged with a front-rear direction set as a longitudinal direction. The entirety of the plurality of first recesses 41 is referred to as a first group 41G. The first group 41G is located at the center of the cushioning material 30 in the vehicle width direction.

Similarly, the plurality of second recesses 42 to the plurality of fourth recesses 44 are arranged with the front-rear direction set as a longitudinal direction. The plurality of second recesses 42 to the plurality of fourth recesses 44 are referred to as a second group 42G to a fourth group 44G, respectively. The fourth groups 44G are located at both ends of the cushioning material 30 in the vehicle width direction. Namely, the first group 41G to the fourth group 44G are arranged in order in a direction away from the center in the vehicle width direction. Incidentally, the second groups 42G to the fourth groups 44G are left-right symmetrical with respect to the first group 41G.

Referring to FIG. 5, in the first group 41G, the first recesses 41 are disposed in a staggered pattern. When the centers of three first recesses 41 that are adjacent and closest to each other are connected, a triangle T1 is obtained. An angle θ1 formed by two adjacent sides forming the triangle T1 is approximately 55 degrees to 65 degrees.

The above description also applies to the second group 42G to the fourth group 44G. Namely, in the second group 42G to the fourth group 44G, the second recesses 42 to the fourth recesses 44 are disposed in a staggered pattern.

Further, in the groups adjacent to each other, when the centers of three recesses that are adjacent and closest to each other are connected, a triangle is obtained. For example, as for one third recess 43 of the third group 43G and two fourth recesses 44 of the fourth group, when the centers of the recesses are connected, a triangle T2 is obtained. An angle θ2 formed by two adjacent sides forming the triangle T2 is approximately 55 degrees to 65 degrees.

With the above configuration, it can be said that the first recesses 41 to the fourth recesses 44 are disposed in a staggered pattern not only in each group but also in the entirety of the plurality of recesses 40.

The centers of the first recesses 41 to the centers of the fourth recesses 44 are located straight with respect to the vehicle width direction (left-right direction) (refer to a straight line L1). In other words, spacings (pitches) between the recesses 40 adjacent to each other in the vehicle width direction are equal.

Any recess 40 of the first recesses 41 to the fourth recesses 44 is located on a randomly straight line extending in the front-rear direction in the cushioning material 30. For example, the second recesses 42 and 42 are located on a straight line L2.

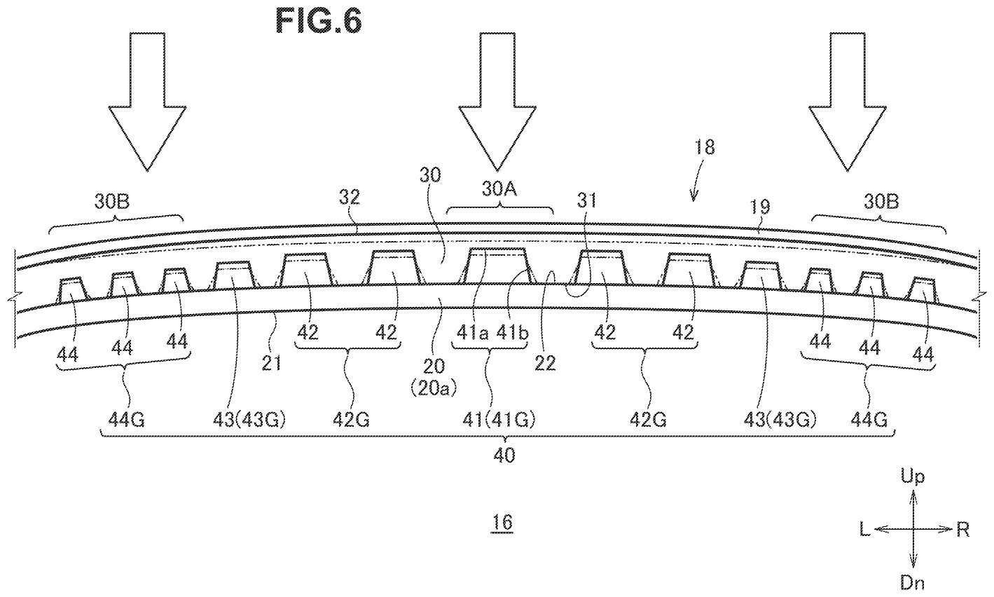

Referring to FIG. 5 and FIG. 6, the armrest 18 includes the base material 20; the cushioning material 30 superimposed on the base material 20; and the skin 19 covering the cushioning material 30. The first superimposed surface 22 of the cushioning material 30 includes the plurality of recesses 40. The plurality of recesses 40 includes the first recesses 41 to the fourth recesses 44 having different volumes.

The volume of the first recess 41 is at its largest. Namely, in a portion of the cushioning material 30 in which the first group 41G is located, the amount of mass removal is large. The first group 41G forms a low-elasticity portion 30A that is easy to be elastically deformed. The low-elasticity portion 30A is easy to be compressed, and the center of the armrest 18 can be set at its softest.

The fourth recesses 44 have the smallest volume. Namely, in a portion of the cushioning material 30 in which the fourth group 44G is located, the amount of mass removal is small. The fourth groups 44G form high-elasticity portions 30B and 30B that are hard to be elastically deformed than the low-elasticity portion 30A. The high-elasticity portions 30B and 30B are hard to be compressed, and both ends of the armrest 18 can be set at its hardest.

Therefore, the cushioning material 30 is a single body but includes the low-elasticity portion 30A and the high-elasticity portions 30B and 30B. A cushioning property of the armrest 18 can be changed by only the cushioning material 30 which is a single body, through combining a plurality of types of the recesses 40 (41 to 44) having different volumes (diameters, depths, or the like of holes), instead of a combination of a plurality of the cushioning materials. The armrest 18 has different cushioning properties depending on a portion, while suppressing the cost.

Incidentally, an existing armrest (not illustrated) may include a base material and a resin member made of resin which is superimposed on the base material and which is elastically deformable. The resin member includes a large number of protrusions extending from a back surface of the resin member toward the base material. Tips of the protrusions are in contact with the base material. When a load is applied to the armrest, each protrusion is elastically deformed to provide a cushioning property to the armrest.

In the armrest including a large number of such protrusions, the cushioning property of the armrest can be adjusted by changing the length of the protrusions in a protruding direction. However, since the length of the protrusions is changed, an outer shape or design of the armrest is affected with respect to an armrest in which the length of protrusions are uniform, which is a problem.

In the armrest 18 of the first embodiment, a change in the thickness of the cushioning material 30 to adjust the cushioning property is not made. It is sufficient to form the plurality of recesses 40 in the existing cushioning material 30, and the existing cushioning material 30 is highly versatile without affecting the outer shape or design of the armrest 18.

The first recesses 41 having a large volume to the fourth recesses 44 having a small volume are arranged in order from the center of the armrest 18 toward an outer side in the vehicle width direction (left-right direction). Namely, the four types of recesses having different volumes are formed, and the recesses 40 are arranged in order of size of volume. An elasticity characteristic of the cushioning material 30 can be gradually changed. The armrest 18 has a smooth and natural cushioning property.

Referring to FIG. 4, the first recesses 41 to the fourth recesses 44 are located in a staggered pattern as a whole. Namely, the recesses are unbiasedly and evenly located on the second superimposed surface. The armrest 18 has a constant cushioning property regardless of the portion thereof.

The first recesses 41 to the fourth recesses 44 have a truncated cone shape. For this reason, when the cushioning material 30 is manufactured by molding using a mold, the cushioning material 30 is easily released from the mold. Incidentally, a method for molding a truncated cone is not limited to molding using a mold, and a known method can be adopted.

Effects of the first embodiment are also exhibited in a second embodiment to be described later. Particular effects of the first embodiment will be described below.

The first recesses 41 to the fourth recesses 44 are formed in the cushioning material 30. In the second embodiment to be described later, recesses are formed in the base material 20 having a predetermined rigidity. The recesses can be easily formed compared to the second embodiment.

A cushioning material may be three-dimensionally molded in advance according to the shape of the base material. The cushioning material 30 (30a) having a plate shape and having high versatility as in the first embodiment may be used. The recesses are formed in the cushioning material 30 having a plate shape of the first embodiment. The cushioning material 30 is easy to be deformed compared to a normal cushioning material in which recesses are not formed. For this reason, in a process of manufacturing the armrest 18, superimposing work is facilitated in a cushioning material superimposing process of superimposing the cushioning material 30 on the base material 20.

Referring to FIG. 3, the main body portion 20a of the base material 20 is curved to bulge upward. The cushioning material 30 is also easily superimposed on the base material 20 that is curved in such a manner.

### Second Embodiment

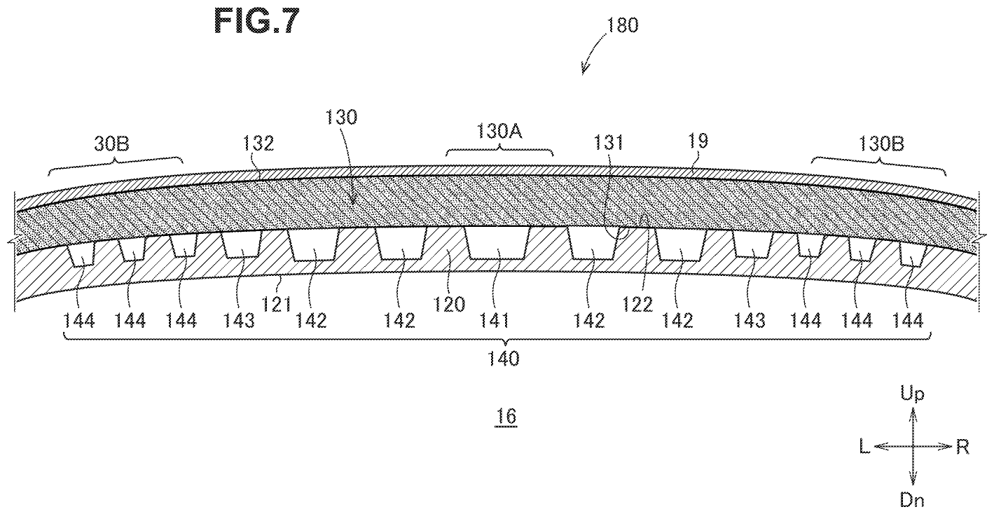

Referring to FIG. 7, configurations common to the first embodiment are denoted by the same reference signs as those of the first embodiment, and the descriptions thereof will not be repeated. An armrest 180 of a second embodiment includes a base material 120 (first member); a cushioning material 130 (second member) superimposed on the base material 120; and the skin 19 covering the cushioning material 130.

A first superimposed surface 122 of the base material 120 includes a plurality of recesses 140 that are open toward a second superimposed surface 131 of the cushioning material 130. The insides of the plurality of recesses 140 do not communicate with each other. Namely, the recesses 140 are independent of each other.

The plurality of recesses 140 includes first recesses 141 to fourth recesses 144 having different volumes. The volume decreases in order from the first recesses 141 to the fourth recesses 144. Namely, the volume of the first recesses 141 (large recesses) is at its largest, and the volume of the fourth recesses 144 (small recesses) is at its smallest. Further, a diameter of an edge of the recess 140 is at its largest in the first recess 141, and is at its smallest in the fourth recess 144.

The first recesses 141 are located at the center of the cushioning material 130 in the vehicle width direction. The fourth recesses 144 are located at both ends of the cushioning material 130 in the vehicle width direction. Namely, the volume and the diameter of the edge of the recess 140 decrease from the center toward an end portion of the cushioning material 130. The shape of the recesses 140 and the positions of the recesses 140 in the first superimposed surface 122 are the same as those of the first embodiment, and the descriptions thereof will not be repeated.

The diameter of the edge of the recess 140 is at its largest in the first recess 141. Namely, an area of a support surface that supports the cushioning material 130 is small in portions of the first superimposed surface 122 of the base material 120 in which the first recesses 141 are located. Portions of the cushioning material 130 which face the first recesses 141 form a low-elasticity portion 130A that is easy to be elastically deformed (is easy to be recessed).

The diameter of the edge of the recess 140 is at its smallest in the fourth recesses 144. Namely, an area of a support surface that supports the cushioning material 130 is larger in portions of the first superimposed surface 122 of the base material 120, in which the fourth recesses 144 are located, than in the portions in which the first recesses 141 are located. Portions of the cushioning material 130 which face the fourth recesses 144 form a high-elasticity portion 130B that is hard to be elastically deformed (is hard to be recessed) than the low-elasticity portion 130A.

Namely, the cushioning material 130 is a single body but includes the low-elasticity portion 130A and the high-elasticity portion 130B. A cushioning property of the armrest 180 can be changed by only the cushioning material 130 that is a single body, instead of a plurality of the cushioning materials.

### Third Embodiment

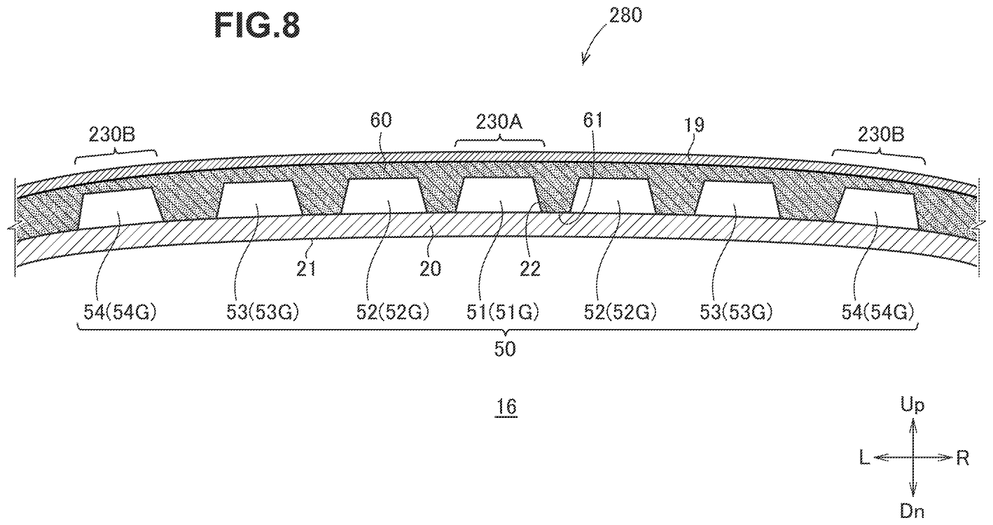

Referring to FIG. 8, configurations common to the first embodiment are denoted by the same reference signs as those of the first embodiment, and the descriptions thereof will not be repeated. An armrest 280 of a third embodiment includes the base material 20 (first member); a cushioning material 60 (second member) superimposed on the base material 20; and the skin 19 covering the cushioning material 60.

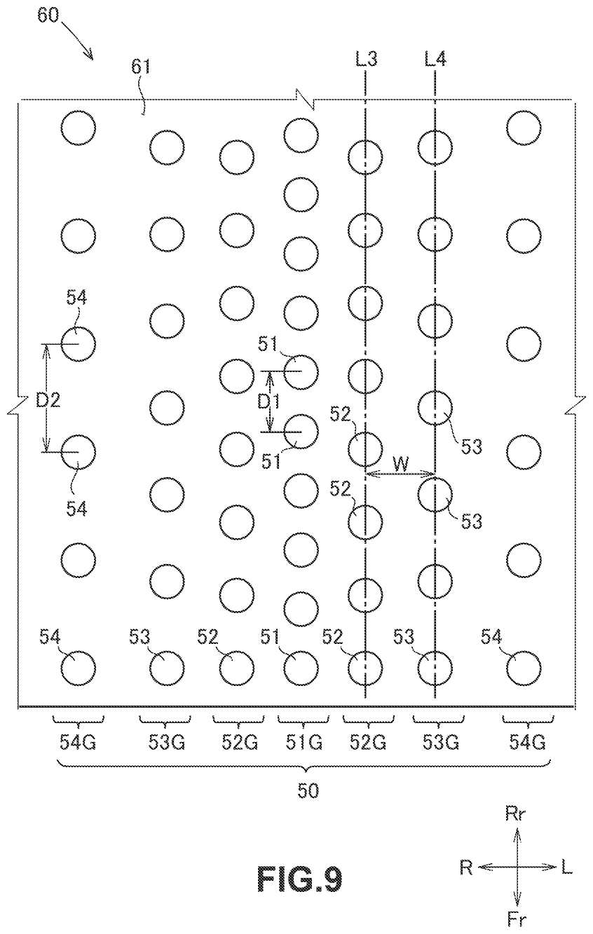

Referring to FIG. 8 and FIG. 9, a second superimposed surface 61 of the cushioning material 60 includes a plurality of recesses 50 that are open toward the first superimposed surface 22 of the base material 20. The insides of the plurality of recesses 50 do not communicate with each other. Namely, the recesses 50 are independent of each other. The shapes (for example, a truncated conical shape) and the volumes of the recesses 50 are the same.

Among the plurality of recesses 50, recesses located at the center in the vehicle width direction are referred to as first recesses 51, and recesses from the first recesses 51 toward an outer side in the vehicle width direction (left-right direction) are referred to as second recesses 52 to fourth recesses 54. The entirety of the first recesses 51 arranged in the front-rear direction is referred to as a first group 51G. Similarly, the second recesses 52 to the fourth recesses 54 arranged in the front-rear direction are referred to as a second group 52G to a fourth group 54G. The second groups 52G to the fourth groups 54G are left-right symmetrical with respect to the first group 51G.

In each of the groups 51G to 54G, spacings between the recesses 50 adjacent to each other are equal. For example, in the first group 51G, any spacing between the recesses 51 and 51 adjacent to each other in the front-rear direction is a spacing D1. In the fourth group 54G, any spacing between the recesses 54 and 54 adjacent to each other in the front-rear direction is a spacing D2. When the spacings between the recesses 50 adjacent to each other in the front-rear direction are compared to each other, the spacings are set to be wider in order from the first group 51G (dense portion) to the fourth group 54G (sparse portion). Namely, the spacing D1 is at its narrowest, and the spacing D2 of the fourth group 54G is at its widest (D1<D2). Incidentally, the dense portion and the sparse portion can be appropriately selected from the first group 51G to the fourth group 54G as long as a relative size relationship is satisfied.

A spacing between a line L3 passing through the centers of the second recesses 52 and a line L4 passing through the centers of the third recesses 53 is defined as a spacing W between the second group 52G and the third group. The spacing W between the adjacent groups defined in such a manner is set to be wider toward the outer side in the vehicle width direction.

The spacing D1 between the recesses 50 forming the first group 51G is set to be narrower than the spacings between the recesses 50 forming the second group 52G to the fourth group 54G. Namely, in a portion of the cushioning material 60 in which the first group 51G is located, the recesses 50 are dense and the amount of mass removal is large. The first group 51G forms a low-elasticity portion 230A that is easy to be elastically deformed. The low-elasticity portion 230A is easy to be compressed, and the center of the armrest 280 can be set at its softest.

The spacing D2 between the recesses 50 forming the fourth group 54G is set to be wider than the spacings between the recesses 50 forming the first group 51G to the third group 53G. Namely, in a portion of the cushioning material 60 in which the fourth group 54G is located, the recesses 50 are scattered and the amount of mass removal is small. The fourth groups 54G form high-elasticity portions 230B and 230B that are hard to be elastically deformed than the low-elasticity portion 230A. The high-elasticity portions 230B and 230B are hard to be compressed, and both ends of the armrest 280 can be set at its hardest.

Therefore, the cushioning material 60 is a single body but includes the low-elasticity portion 230A and the high-elasticity portions 230B and 230B. A cushioning property of the armrest 280 can be changed by only the cushioning material 60 which is a single body, through combining the plurality of recesses 50 having different spacings between the recesses 50, instead of a combination of a plurality of the cushioning materials 60. The armrest 280 has different cushioning properties depending on a portion, while suppressing the cost.

As described above, the spacing (refer to the spacings D1 and D2) between the recesses 50 adjacent to each other in the same group increases from the first group 51G toward the fourth group 54G. Further, the spacing W between the adjacent groups increases from the center of the armrest 280 toward the outer side in the vehicle width direction (left-right direction). Therefore, an elasticity characteristic of the cushioning material 60 can be widely changed.

Incidentally, in the third embodiment, the spacing between the recesses adjacent to each other in the front-rear direction and in the left-right direction is changed, but is not limited to being changed in the front-rear direction and in the left-right direction, and as long as the elasticity characteristic of the cushioning material 60 can be changed for each portion by changing the spacing between the recess 50 and the surrounding recesses 50, the positions of the recesses 50 can be changed as appropriate.

Incidentally, the invention is not limited to the embodiments as long as the actions and the effects of the invention are exhibited. The depth of the recess, the diameter of the edge of the recess, the positions or the number of the recesses, or the like can be appropriately changed to the extent that an occupant cannot recognize the recesses when the occupant touches the armrest 18 or 180. Further, the interior structure for vehicle is not limited to the center console, may be adopted for an armrest provided in a door trim, and may be applied to any portion in the passenger compartment.

What is claimed is:

1. An interior structure for vehicle comprising:
a first member having a first superimposed surface; and
a second member having a second superimposed surface superimposed on the first superimposed surface, and being elastically deformable,
wherein the second member comprises a low-elasticity portion that is easy to be elastically deformed, and a high-elasticity portion that is hard to be elastically deformed than the low-elasticity portion,
one of the first superimposed surface and the second superimposed surface comprises a plurality of recesses that are open toward the other superimposed surface, and that are independent of each other without communicating with each other,
the plurality of recesses comprise a plurality of large recesses having a large volume, and a plurality of small recesses having a smaller volume than the volume of the plurality of large recesses,
portions in which the plurality of large recesses are located form the low-elasticity portion of the second member, and
portions in which the plurality of small recesses are located form the high-elasticity portion of the second member.

2. An interior structure for vehicle comprising:
a first member having a first superimposed surface; and
a second member having a second superimposed surface superimposed on the first superimposed surface, and being elastically deformable,
wherein the second member comprises a low-elasticity portion that is easy to be elastically deformed, and a high-elasticity portion that is hard to be elastically deformed than the low-elasticity portion,
one of the first superimposed surface and the second superimposed surface comprises a plurality of recesses that are open toward the other superimposed surface, and that are independent of each other without communicating with each other,
shapes and volumes of the recesses are the same as each other,
the plurality of recesses comprise a dense portion in which a spacing between the recesses is set to be narrow, and a sparse portion in which a spacing between the recesses is set to be wider than the spacing of the dense portion,
the dense portion forms the low-elasticity portion of the second member, and
the sparse portion forms the high-elasticity portion of the second member.

3. The interior structure for vehicle according to claim 1,
wherein the second superimposed surface of the second member comprises the plurality of recesses.

4. The interior structure for vehicle according to claim 2,
wherein the second superimposed surface of the second member comprises the plurality of recesses.

5. The interior structure for vehicle according to claim 1,
wherein the plurality of recesses are located in a staggered pattern as a whole.

6. The interior structure for vehicle according to claim 2,
wherein the plurality of recesses are located in a staggered pattern as a whole.

7. The interior structure for vehicle according to claim 3,
wherein the plurality of recesses are located in a staggered pattern as a whole.

8. The interior structure for vehicle according to claim 4,
wherein the plurality of recesses are located in a staggered pattern as a whole.

9. The interior structure for vehicle according to claim 1,
wherein the plurality of recesses have a truncated conical shape.

10. The interior structure for vehicle according to claim 2,
wherein the plurality of recesses have a truncated conical shape.

11. The interior structure for vehicle according to claim 3,
wherein the plurality of recesses have a truncated conical shape.

12. The interior structure for vehicle according to claim 4,
wherein the plurality of recesses have a truncated conical shape.

13. The interior structure for vehicle according to claim 5,
wherein the plurality of recesses have a truncated conical shape.

14. The interior structure for vehicle according to claim 6,
wherein the plurality of recesses have a truncated conical shape.

15. The interior structure for vehicle according to claim 7,
wherein the plurality of recesses have a truncated conical shape.

16. The interior structure for vehicle according to claim 8,
wherein the plurality of recesses have a truncated conical shape.
